(19) United States
(12) Patent Application Publication
(10) Pub. No.: US 2015/0074924 A1
(43) Pub. Date: Mar. 19, 2015

(54) ONE-PIECE RAMP

(71) Applicant: Cequent Consumer Products, Inc., Solon, OH (US)

(72) Inventor: Francis Bernart, North Canton, OH (US)

(73) Assignee: Cequent Consumer Products, Inc., Solon, OH (US)

(21) Appl. No.: 14/293,430

(22) Filed: Jun. 2, 2014

Related U.S. Application Data
(60) Provisional application No. 61/829,424, filed on May 31, 2013.

(51) Int. Cl. B65G 69/30

(52) U.S. Cl. CPC B65G 69/30
USPC 14/69.5

(57) ABSTRACT

A ramp is shown and described. The ramp may include a frame having first and second end portions and a ramp surface extending substantially between the frame and positioned between the first and second end portion. The ramp may also include a plate extending at least partially between the frame and positioned adjacent to at least one of the first and second end portions, where the frame, ramp surface and plate are monolithic.

### CROSS-REFERENCE TO RELATED APPLICATION

This application claims the benefit from U.S. Provisional Patent Application No. 61/829,424 entitled “One-Piece Ramp” filed on May 31, 2013, which is hereby incorporated in its entirety by reference.

### FIELD OF THE INVENTION

The present invention is generally related to a ramp and, more particularly, to a one-piece monolithically formed ramp.

### BACKGROUND

Many transport vehicles are designed to transport freight, goods, merchandise, personal property, and other such cargo. Often, such transport vehicles utilize a load bed to haul such cargo. For example, operators often utilize the load bed of a pick-up truck to haul cargo. The load bed, however, is often elevated from the ground making it difficult to load and unload heavy objects from such load beds. Accordingly, operators will utilize a ramp that extends from the ground upwards to the load bed of the transporting vehicle to load and unload heavy objects.

Numerous types of ramps are used to assist in the loading and unloading of objects to and from transport vehicles. Particularly, trucks, vans, trailers and the like may utilize ramps to assist in the loading of rolling objects such as ATVs, motorcycles, lawnmowers, etc. One common type of ramp consists of a plurality of rungs whereby each rung is separated from a successive rung by an open space. The rungs may be connected at or near the ends by rails. The successive rungs and the rails form a series of frame-like structures surrounding the central openings, similar to a ladder. Such a structure allows for loading and unloading of objects, such as ATVs, motorcycles, lawnmowers and etc. to and from the transport vehicle.

The surface of the ramp will often be at a different angle than the top loading surface of the transporting vehicle. The ramp may utilize a top plate that engages the top of the ramp to the loading surface. The components that form the ramp are often formed and then attached together through subsequent operations such as welding or fastening and the like. For example, each rung of the ramp may be welded, fastened or otherwise attached to the pair of opposed frame members. Further, the top or bottom plate may be welded or fastened to the opposed frame members. This may result in a ramp that is expensive and time consuming to construct.

Therefore, there is a need for an improved ramp that reduces the time and effort required to manufacture. Further, there is a need for a ramp that is not assembled or otherwise formed through welding. Further still, there is a need from a ramp that can withstand the forces applied to it during operation will maintaining a sleek profile and relatively low weight.

### SUMMARY

A ramp is shown and described. The ramp may include a frame having first and second end portions and a ramp surface extending substantially between the frame and positioned between the first and second end portion. The ramp may also include a plate extending at least partially between the frame and positioned adjacent to at least one of the first and second end portions, where the frame, ramp surface and plate are monolithic.

A ramp may include a frame having first and second end portions and a ramp surface extending substantially between the frame and positioned between the first and second end portions. The ramp may also include a plate extending at least partially between the frame and positioned adjacent to at least one of the first and second end portions, where the frame, ramp surface and plate are weld free.

A ramp may include first and second frame member transversely opposed one another, the first and second frame members having first and second end portions, and a ramp surface extending substantially between the first and second frame members and positioned between the first and second end portions. The ramp may also include a plate extending at least partially between the first and second frame members and positioned adjacent to at least one of the first and second end portions of the first and second frame members, where the first and second frame members, ramp surface and plate are monolithic.

### BRIEF DESCRIPTION OF THE DRAWINGS

Operation of the invention may be better understood by reference to the following detailed description taken in connection with the following illustrations, wherein:

FIG. 1 is a perspective view of an embodiment of a one-piece ramp.

FIG. 2 is a side view of the one-piece ramp.

FIG. 3 is a bottom view of the one-piece ramp.

FIG. 4 is a top view of the one-piece ramp.

FIG. 5 is a cross-sectional view of the one-piece ramp of FIG. 4 along line E-E.

FIG. 6 is a detailed view of a portion of the one-piece ramp along circular F of FIG. 4.

FIG. 7 is a cross-sectional view of the one-piece ramp of FIG. 4 along line C-C.

FIG. 8 is a cross-sectional view of the one-piece ramp of FIG. 4 along line A-A.

FIG. 9 is a cross-sectional view of the one-piece ramp of FIG. 2 along line B-B.

FIG. 10 is a top view of a portion of a one-piece ramp extruded as a monolithic unit with extended frame members attached.

FIG. 11 is a top view of a portion of the one-piece ramp of FIG. 10 with the extended frame members removed.

FIG. 12 is a perspective view of an embodiment of a one-piece ramp.

FIG. 13 is a rear perspective view of the embodiment of the one-piece ramp of FIG. 12.

FIG. 14 is a perspective view of an embodiment of a one-piece ramp.

FIG. 15 is a perspective view of an embodiment of a one-piece ramp.

FIG. 16 is a rear perspective view of the embodiment of the one-piece ramp of FIG. 15.

FIG. 17 is a perspective view of an embodiment of a one-piece ramp.

FIG. 18 is a cross-sectional view of the embodiment of the one-piece ramp of FIG. 17 along line 18-18.

FIG. 19 is a cross-sectional view of an embodiment of a one-piece ramp.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

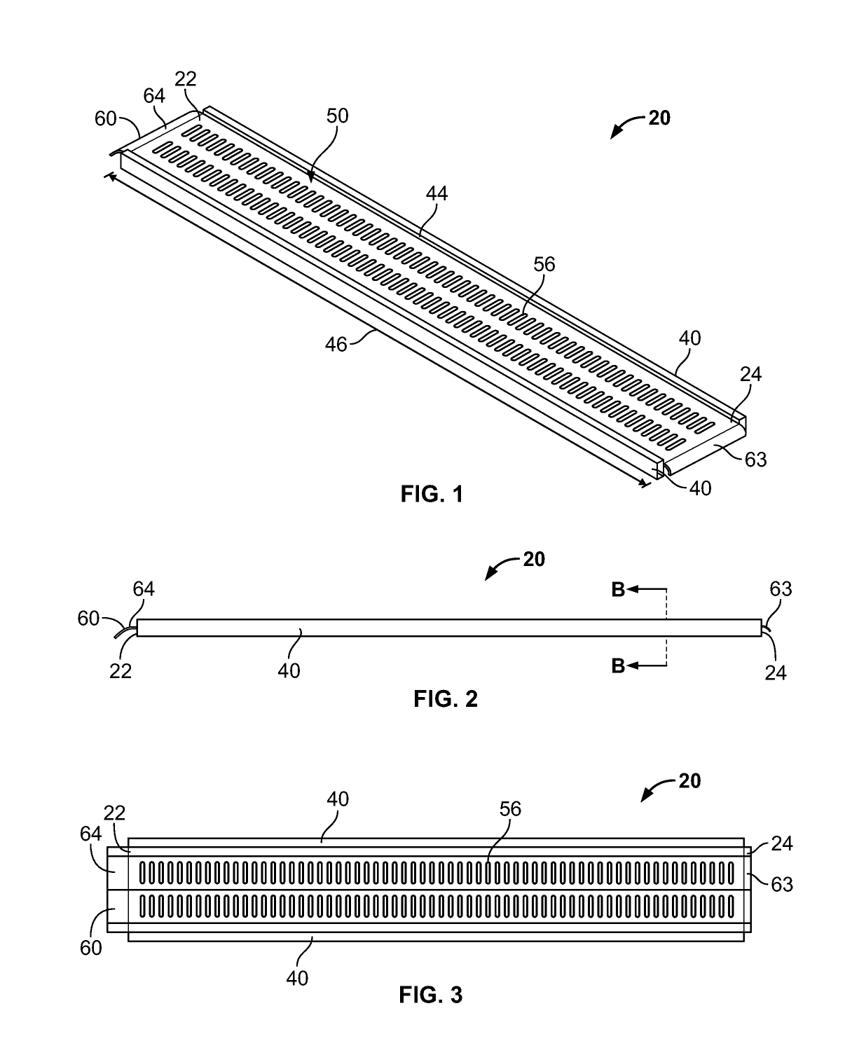

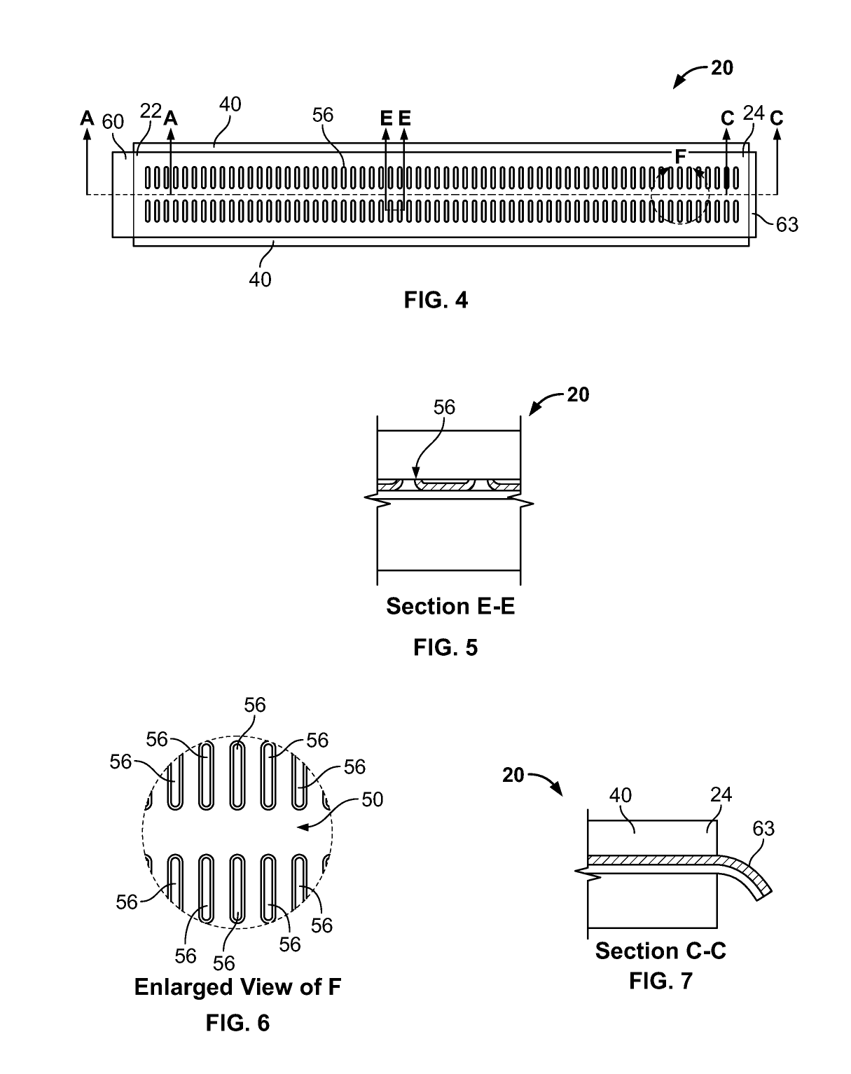

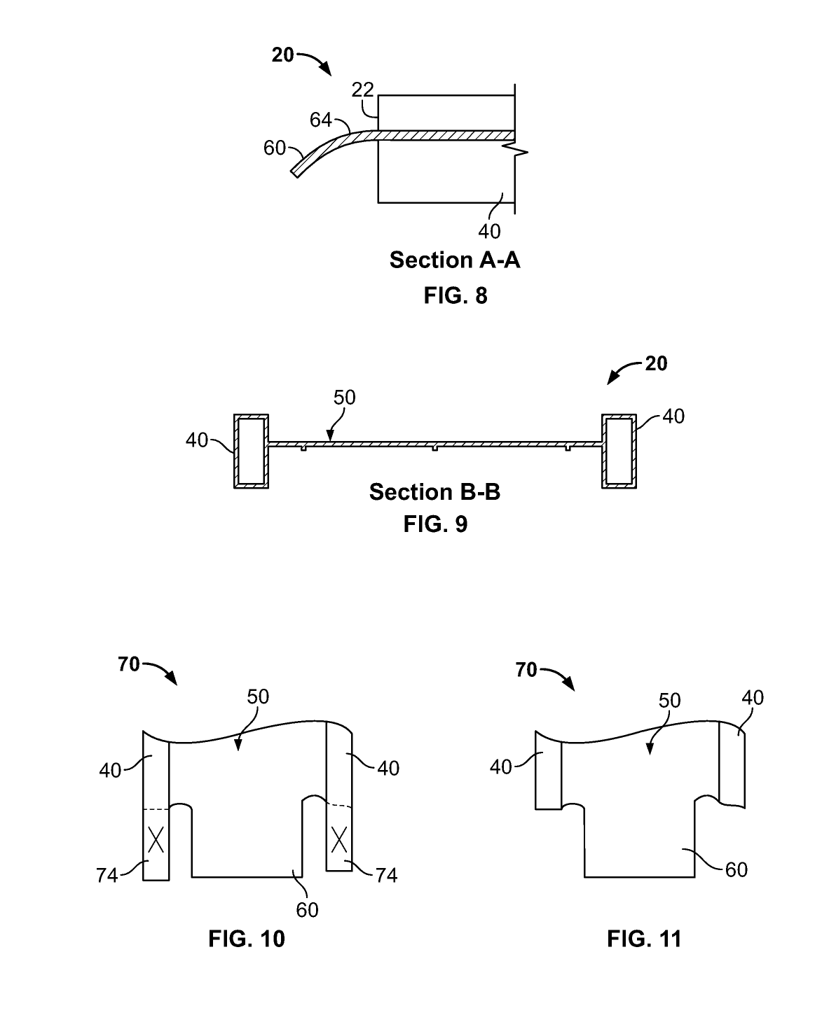

An exemplary embodiment of a one-piece ramp 20 is illustrated in FIGS. 1-9. The ramp 20 may be formed as a monolithic unit as described in more detail below. The ramp 20 may include first and second ends 22, 24. The ramp 20 may be configured to span from a transport vehicle (not shown) or loading surface to and from a second surface (not shown), such as the ground. By way of a non-limiting example, the first end 22 of the ramp 20 may engage a load bed (not shown) of the transport vehicle and the second end 24 may engage the ground. It should be understood, however, the second end 24 may engage the loading surface and the first end 22 engage the ground.

The ramp 20 may be of any appropriate shape, size, type or configuration, whereby it may extend at an appropriate angle between the transport vehicle or loading surface, and specifically the load bed thereof, and the second surface such as the ground. By way of a non-limiting example, the ramp 20 may extend from a rear portion of the load bed of the transport vehicle to the ground at an appropriate angle, such as by way of a non-limiting example between 9 and 28 degrees relative to the ground.

The length of ramp 20 may be selected for the type of transport vehicle and the desired slope for loading and unloading. By way of a non-limiting example, if the transport vehicle is a typical trailer a length of about six feet may provide a desirable slope, and if the transport vehicle is a light pickup truck a length of about eight feet may provide a desirable slope. The present teachings, however, are not limited to any particular length ramp 20 and the ramp 20 may be of any appropriate length.

The ramp 20 may include at least one frame member 40. In embodiments shown in FIGS. 1-9, the ramp 20 may include a pair of frame members 40. The frame members 40 may be laterally disposed from each other at an appropriate distance. The present teachings, however, are not limited to the two frame members 40 shown. Any appropriate number of frame members 40 may be used. The frame members 40 may be of any appropriate cross-sectional shape, including, without limitation, boxed, I-beam or the like—an example of which can be seen in detail in FIG. 9.

The frame members 40 may include a raised lip 44 that may extend at least a portion of a length 46 of the frame members 40. As shown in the drawings, the raised lip 44 may extend the entire length 46 of the frame members 40, or alternatively, may extend only a portion of the length 46 of the frame members 40. The raised lip 44 may be monolithically formed with the frame members 40 in any appropriate manner. Moreover, while each frame member 40 is shown with a raised lip 44, only one such frame member 40 may include the raised lip 44 or none of the frame members 40 may include the raised lip 44. The raised lip 44 may be constructed and arranged to assist with preventing rolling loads being loaded or unloaded on the ramp 20 from unintentionally moving off the side of the ramp 20.

The ramp 20 may include a ramp surface 50 of any appropriate configuration. The ramp surface 50 may be monolithically formed with the frame members 40. The ramp surface 50 may be configured such that loads may be pushed or pulled up or down, as applicable. By way of a non-limiting example, the loads may be manually pushed up or down the ramp surface 50 or a winch may be utilized for such. As shown in FIGS. 1 and 9, the frame members 40 may extend generally above the ramp surface 50 whereby the portion of the frame member 40 extending above the ramp surface 50 may form the raised lip 44.

The ramp surface 50 may include a plurality of apertures 56 spaced apart from one another. As shown in FIGS. 1, 3 and 4, the plurality of the apertures 56 may be generally aligned in two rows. The present teachings, however, are not limited to this configuration—any appropriate configuration may be used. Any number of aligned rows may be used. Further, still, the apertures 56 may be positioned in any pattern or no pattern, i.e., randomly positioned, on the ramp surface 50. The spacing of the apertures 56 on the ramp surface 50 may be selected such that it is substantially less than the width of a wheel or the like of any item that may be loaded or unloaded on the ramp 20 such that it will not engage any of the apertures 56.

The apertures 56 may be of any appropriate configuration. By way of a non-limiting example, the apertures 56 may be generally oval in shape. The present teachings, however, are not limited to this configuration. As shown in FIGS. 1 and 3, the apertures 56 may extend through the entire ramp surface 50. In some embodiments, the apertures 56 may be positioned in only a portion of the ramp surface 50, such as a cut-out portion that may not extend through the entirety of the ramp surface 50. The apertures 56 may reduce the amount of material utilized with the ramp 20, which may reduce the overall weight of the ramp 20. Further, the apertures 56 may provide additional traction between the item being pushed or pulled up or down the ramp 20 and the ramp surface 50. By way of a non-limiting example, a portion of the aperture 56 may extend above the ramp surface 50, which may provide the traction surface. The apertures 56 may be formed with the ramp 20. For example, the apertures 56 may be monolithically formed with the ramp surface 50. Alternatively or in addition, the apertures 56 may be formed in the ramp surface 50 through a subsequent operation.

The ramp 20 may further include at least one transition plate 60 that may be monolithically formed with the first end 22 and/or the second end 24 of the ramp 20. In some embodiments shown in FIGS. 1-4 and 8, the transition plate 60 may be monolithically formed with the first end 22 of the ramp 20 to engage the load bed of the transport vehicle. In addition, the ramp 20 may include a second transition plate 63 monolithically formed with the second end 24 of the ramp 20 that may engage the ground; see FIGS. 1-4 and 7. The ramp 20 may include only the second transition plate 63 at the second end 24 of the ramp 20 that may engage the ground—the present teachings are not limited to the configuration shown. Further, the second transition plate 63 may be at the first end 22 and the transition plate 60 at the second end 24. The transition plate and second transition plate 60 and 63 may be monolithically formed with the ramp surface 50, the rails 44 or both.

While the transition plates 60, 63 may be of substantially similar construction, they are not limited to such. Only one of the transition plates 60 will be described in detail below, except as otherwise noted. The transition plate 60 may be shaped to provide clearance underneath the ramp 20 to engage the loading surface (e.g., the load bed of the transport vehicle) and the second transition plate 63 may be shaped to provide a transition surface between the second surface (e.g., the ground) and the ramp surface 50. The transition plate 60 may include a top surface 64, which may provide a substantially continuous surface for a rolling load, i.e., the transition plate 60 or more specifically the top surface 64 may provide a transition surface between the ramp surface 50 and applicable loading surface. This may substantially eliminate or reduce the transition surface when transitioning to and from the ramp 20, which may result in less force required for the rolling load or other object to be pulled or pushed to and from the ramp 20. More specifically, the generally rounded shape on the top surface 64 may make the transition from the ramp 20 to the load bed of the transport vehicle more continuous such that the load may roll over such with less effort.

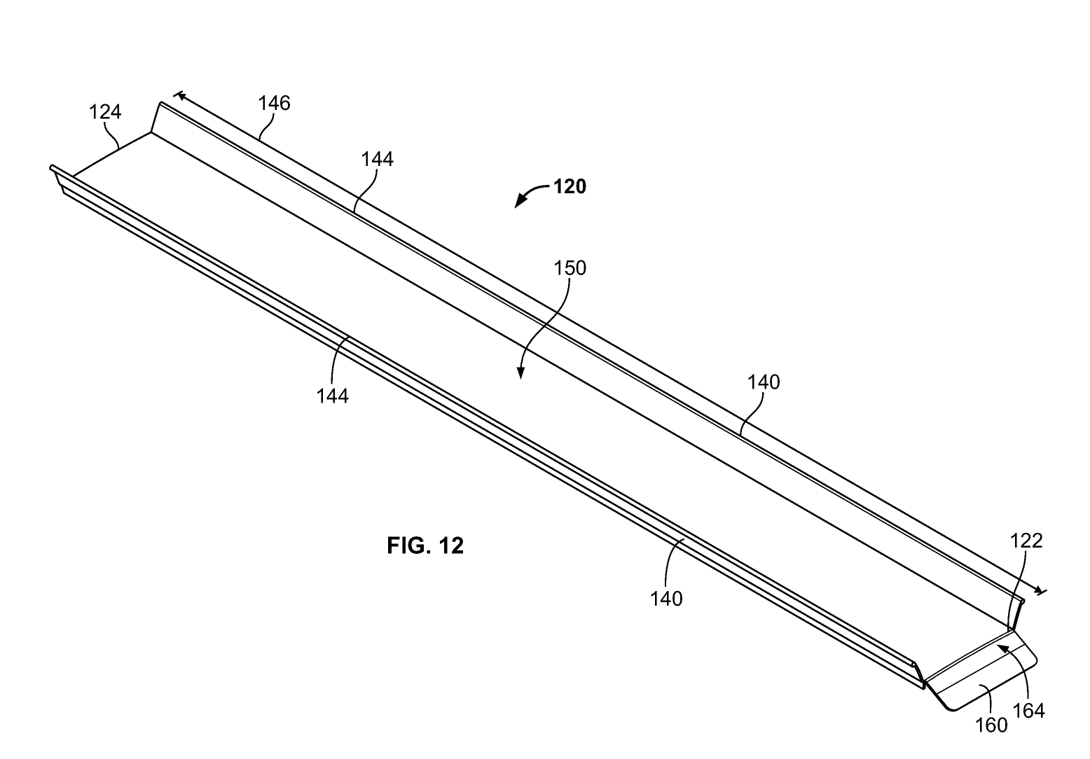

The ramp 20 may be formed as a monolithic unit. In such embodiments, the ramp 20 may be formed such as through extruding. By way of a non-limiting example, the ramp 20 may be extruded as a single piece, which may result in the ramp 20 being a one-piece ramp. In such embodiments, the frame members 40 may be monolithically formed with the ramp surface 50 and the transition plates 60, 63. Any appropriate amount of material, such as by way of a non-limiting example, aluminum, steel, plastic or the like may be extruded to any appropriate shape member 70; see FIGS. 10 and 11. The extruded member 70 may include a sheared end of the ramp 20, which may form the transition plates 60, 63. Further, extruding the ramp may result in a portion 74 of the frame members 40 extending beyond the transition plates 60, 63; see FIG. 10. In such embodiments, the portion 70 may be removed through any appropriate cutting or removing operation and discarded; see FIG. 11. The transition plates 60, 63 may be bent to the appropriate angle relative to the ramp surface 50.

Moreover, the apertures 56 may be formed through the extrusion process or may be formed through a subsequent operation, such as by way of a non-limiting example, punching or drilling the apertures.

In some embodiments, the portion 74 may not be formed with the frame members 40 and as such need not be removed through a subsequent operation. Further, in some embodiments, the transition plates 60, 63 may be formed with the appropriate bend and may not need to be bent during a subsequent operation. Still further, the order of the steps of forming the ramp 20 may be performed in any appropriate order—the present teachings are not limited to the order described. Still further, steps may be skipped and additional steps may be added.

The present teachings generally eliminate the need to weld the ramp 20—as is done in the prior art. When the ramp 20 is made without welding, the ramp 20 may be referred to as being weld free. The process for forming the ramp 20 may minimize the labor required to complete the process. This may allow the ramp 20 to be manufactured quicker and may reduce the overall cost of the ramp 20.

Additional embodiments of the ramp 20 according the present teachings are described below. In the descriptions, all of the details and components may not be fully described or shown. Rather, some of the features or components are described and, in some instances, differences with the above-described embodiment may be pointed out. Moreover, it should be appreciated that these additional embodiments may include elements or components utilized in the above-described embodiment although not shown or described. Thus, the descriptions of these additional embodiments are merely exemplary and not all-inclusive nor exclusive. Moreover, it should be appreciated that the features, components, elements and functionalities of the various embodiments may be combined or altered to achieve a desired ramp without departing from the spirit and scope of the present invention.

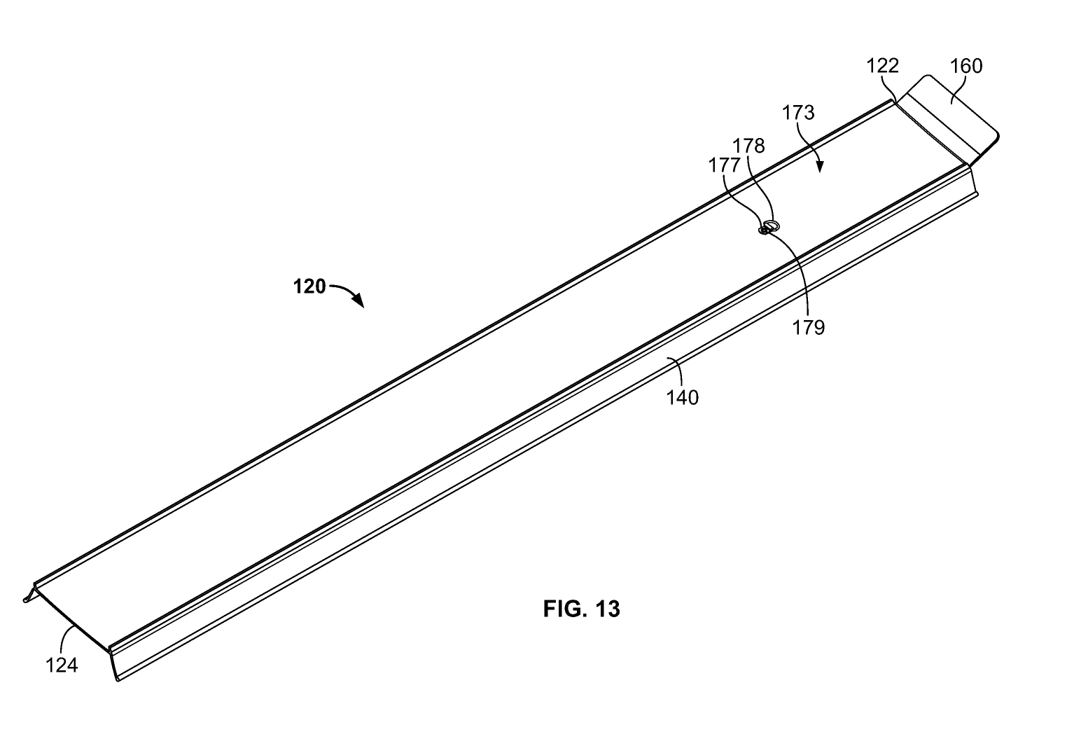

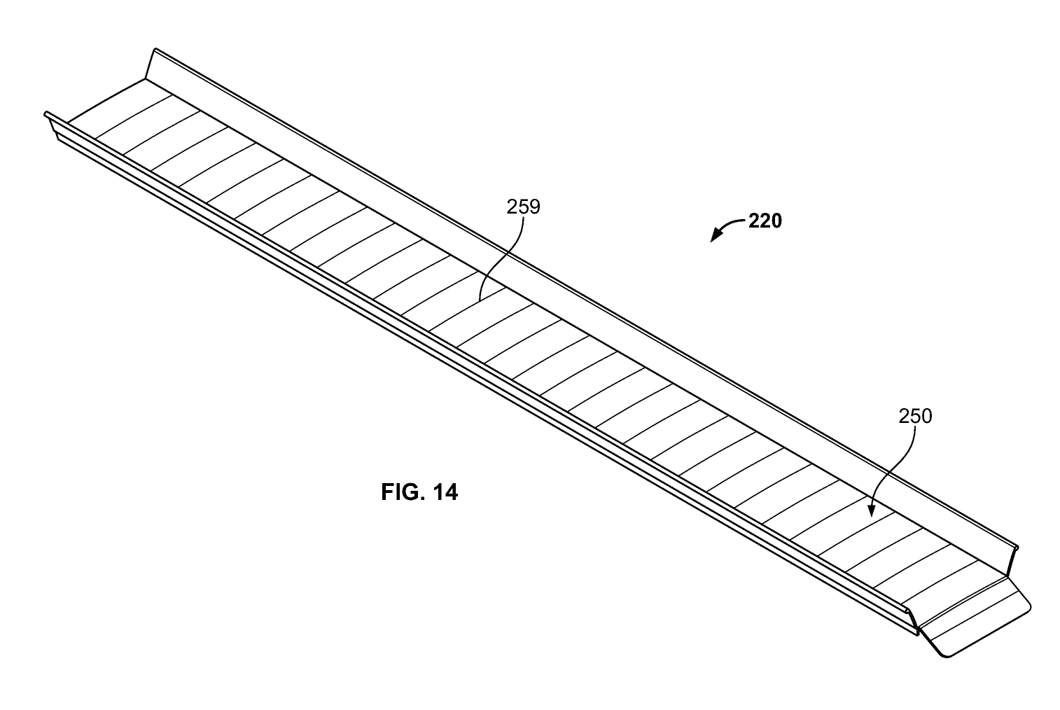

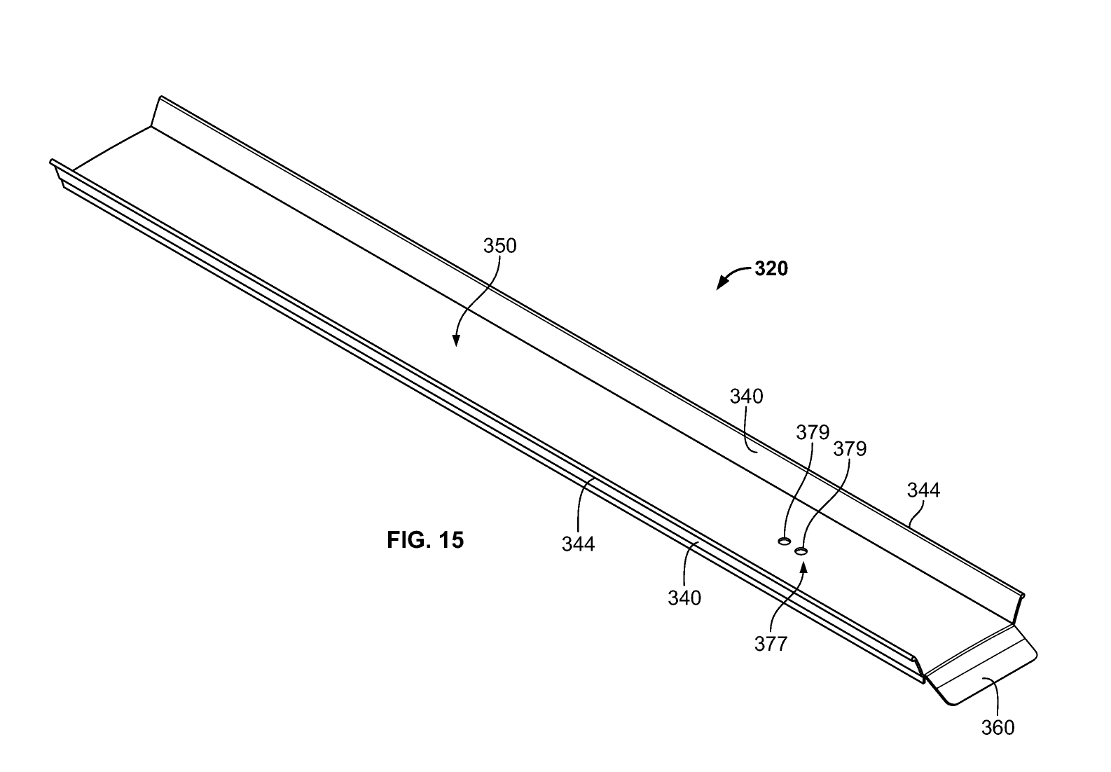

A ramp 120 is shown in FIGS. 12-13. The ramp 120 may include at least one frame member 140, a raised lip 144, and a ramp surface 150. In embodiments shown in FIGS. 12-13, the ramp 120 may include a pair of frame members 140. The frame members 140 may be laterally disposed from each other at an appropriate distance. The frame members 140 may be disposed at an angle relative to the ramp surface 150 as shown. This may result in the raised lips 144 extending from the ramp surface 150 to provide additional clearance for the item being pushed or pulled up or down the ramp 120.

The raised lip 144 that may extend at least a portion of a length 146 of the frame members 140. As shown in the drawings, the raised lip 144 may extend the entire length 146 of the frame members 140, or alternatively, may extend only a portion of the length 146 of the frame members 140. The raised lip 144 may be monolithically formed with the frame members 140 in any appropriate manner. Moreover, while each frame member 140 is shown with a raised lip 144, only one such frame member 140 may include the raised lip 144 or none of the frame members 140 may include the raised lip 144. The raised lip 44 may be constructed and arranged to assist with preventing rolling loads being loaded or unloaded on the ramp 120 from unintentionally moving off the side of the ramp 120.

The ramp surface 150 may be monolithically formed with the frame members 140. The ramp surface 150 may be configured such that loads may be pushed or pulled up or down, as applicable. By way of a non-limiting example, the loads may be manually pushed up or down the ramp surface 150 or a winch may be utilized for such.

The ramp 120 may further include at least one transition plate 160 that may be monolithically formed with a first or second end 120, 124 of the ramp 120. The transition plate 60 may be monolithically formed with the first end 122 of the ramp 120 to engage the load bed of the transport vehicle. The transition plate 160 may be shaped to provide clearance underneath the ramp 120 to engage the loading surface (e.g., the load bed of the transport vehicle) or the second surface (e.g., the ground) and the ramp surface 150. The transition plate 160 may include a top surface 164, which may provide a substantially continuous surface for a rolling load, i.e., the transition plate 160 or more specifically the top surface 164 may provide a transition surface between the ramp surface 150 and applicable loading surface. This may substantially eliminate or reduce the transition surface when transitioning to and from the ramp 120, which may result in less force required for the rolling load or other object to be pulled or pushed to and from the ramp 120.

The ramp 120 may be formed as a monolithic unit. In such embodiments, the ramp 120 may be formed such as through extruding. By way of a non-limiting example, the ramp 120 may be extruded as a single piece, which may result in the ramp 120 being a one-piece ramp. In such embodiments, the frame members 140 may be monolithically formed with the ramp surface 150 and the transition plate 60. Any appropriate amount of material, such as by way of a non-limiting example, aluminum, steel, plastic or the like may be extruded to form the ramp 120. The present teachings may generally eliminate the need to weld the ramp 120—as is done in the prior art. When the ramp 120 is made without welding, the ramp 120 may be referred to as being weld free. The process for forming the ramp 120 may minimize the labor required to complete the process. This may allow the ramp 120 to be manufactured quicker and may reduce the overall cost of the ramp 120.

The ramp 120 may include a bottom surface 173 generally opposite the ramp surface 150. The ramp 120 may include a safety strap engaging member 177 attached with the bottom surface 173 in any appropriate manner—see FIG. 13. By way of a non-limiting example, the safety strap engaging member 177 may be attached through fastening, adhering, welding, integrally forming with the bottom surface 173, monolithically forming with the bottom surface 173 or a combination of such. The safety strap engaging member 177 may be of any appropriate configuration. By way of a non-limiting example, the safety strap engaging member 177 may include a D-ring 178 attached to the bottom surface 173 such as through use of a rivet 179. It should be understood, however, that the strap engaging member 177 may be of any appropriate configuration and is not limited to that shown and described herein. Further, in those embodiments in which the strap engaging member 177 is the D-ring 178, the D-ring 178 may be attached to the bottom surface 173, such as through use of a fastener, welding, adhering or a combination of such.

The strap engaging member 177 may be used to selectively engage the ramp 120 with the loading surface, such as the vehicle to which the ramp 120 operatively engages. By way of a non-limiting example, one end of a safety chain, rope, bungee cord, strap or the like may selectively engage the strap engaging member 177. An opposite end of the applicable safety chain, rope, bungee cord, strap or the like may selectively engage a portion of the loading surface to which the ramp 120 operatively engages, such as the applicable vehicle. This may generally prevent the ramp 120 from being inadvertently moved from its operative position.

In some embodiments as shown in FIG. 14, a ramp 220 may include a ramp surface 250 having a textured finish 259. The textured finish 259 may provide fraction between the item being pushed or pulled up or down the ramp 220 and the ramp surface 250. By way of a non-limiting example, the traction finish 259 may be a knurled surface formed on the ramp surface 250. The knurled surface may be formed monolithically with the ramp surface 250 or formed through a subsequent operation. For example, the textured finish 259 may be formed during the extrusion process or formed through a subsequent operation such as any appropriate knurling process. In some embodiments, the ramp 220 may include both the apertures 56 and the textured finish 259, whereas in other embodiments the ramp 220 may include either of the apertures 56 or the textured finish 259.

Further, the textured surface 259 may include a textured strip of material that may be adhered to the ramp surface 250. Further still, the textured surface 259 may include a diamond pattern finish, raised or depressed bumps, raised or depressed ridges, or any combination of such. The textured surface 259 may provide a suitable surface to generally prevent slippage during loading and unloading of the ramp 220. The present teachings are not limited to the configuration of the textured surface 259 shown or otherwise described herein. Any appropriate textured surface 259 may be utilized without departing from the present teachings.

The present teachings generally eliminate the need to weld the ramp 220—as is done in the prior art. When the ramp 220 is made without welding, the ramp 220 may be referred to as being weld free. The process for forming the ramp 220 may minimize the labor required to complete the process. This may allow the ramp 220 to be manufactured quicker and may reduce the overall cost of the ramp 220.

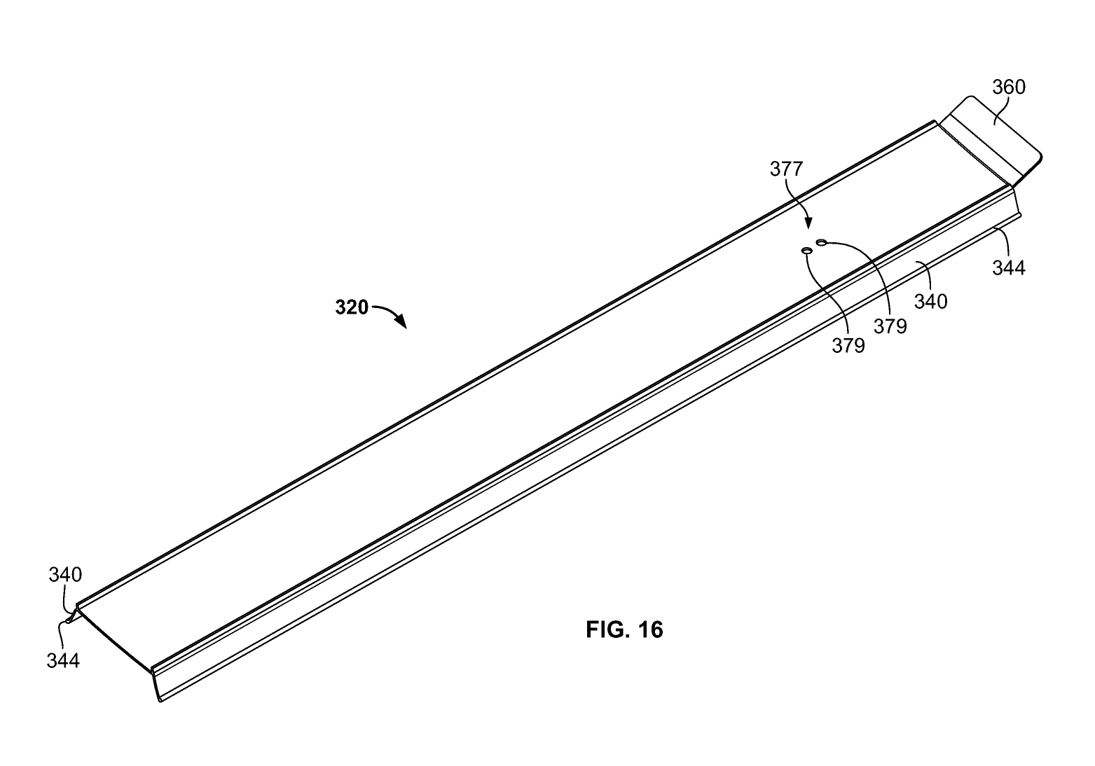

A ramp 320 is shown in FIGS. 15-16. The ramp 320 may include at least one frame member 340, a raised lip 344, a ramp surface 350 and at least one transition plate 360. The ramp 320 may be generally similar ramp 120 described above. The ramp 320 may be formed as a monolithic unit. In such embodiments, the ramp 320 may be formed such as through extruding. By way of a non-limiting example, the ramp 320 may be extruded as a single piece, which may result in the ramp 320 being a one-piece ramp. In such embodiments, the frame members 340 may be monolithically formed with the ramp surface 350 and transition plate 360. Any appropriate amount of material, such as by way of a non-limiting example, aluminum, steel, plastic or the like may be extruded to form the ramp 320.

The ramp 320 may include a bottom surface 373 generally opposite the ramp surface 350. The ramp 320 may include a safety strap engaging member 377 formed with the bottom surface 373 in any appropriate manner—see FIG. 15. By way of a non-limiting example, the safety strap engaging member 377 may be at least aperture 379 formed in the bottom surface 373. As shown, the safety strap engaging member 377 may include a pair of such apertures 379. The safety strap engaging member 377, however, may include any appropriate number of apertures 379, e.g., one, two, three, four, etc. The apertures 379 may be monolithically formed with the bottom surface 373 or formed through a subsequent operation, e.g., stamping, drilling or the like. The apertures 379 may in some embodiments extend through to the ramp surface 350.

The strap engaging member 377 may be used to selectively engage the ramp 320 with the loading surface, such as the vehicle to which the ramp 320 operatively engages. By way of a non-limiting example, one end of a safety chain, rope, bungee cord, strap or the like may selectively engage the strap engaging member 377. An opposite end of the applicable safety chain, rope, bungee cord, strap or the like may selectively engage a portion of the loading surface to which the ramp 320 operatively engages, such as the applicable vehicle. This may generally prevent the ramp 320 from being inadvertently moved from its operative position.

The present teachings generally eliminate the need to weld the ramp 320—as is done in the prior art. When the ramp 320 is made without welding, the ramp 320 may be referred to as being weld free. The process for forming the ramp 320 may minimize the labor required to complete the process. This may allow the ramp 320 to be manufactured quicker and may reduce the overall cost of the ramp 320.

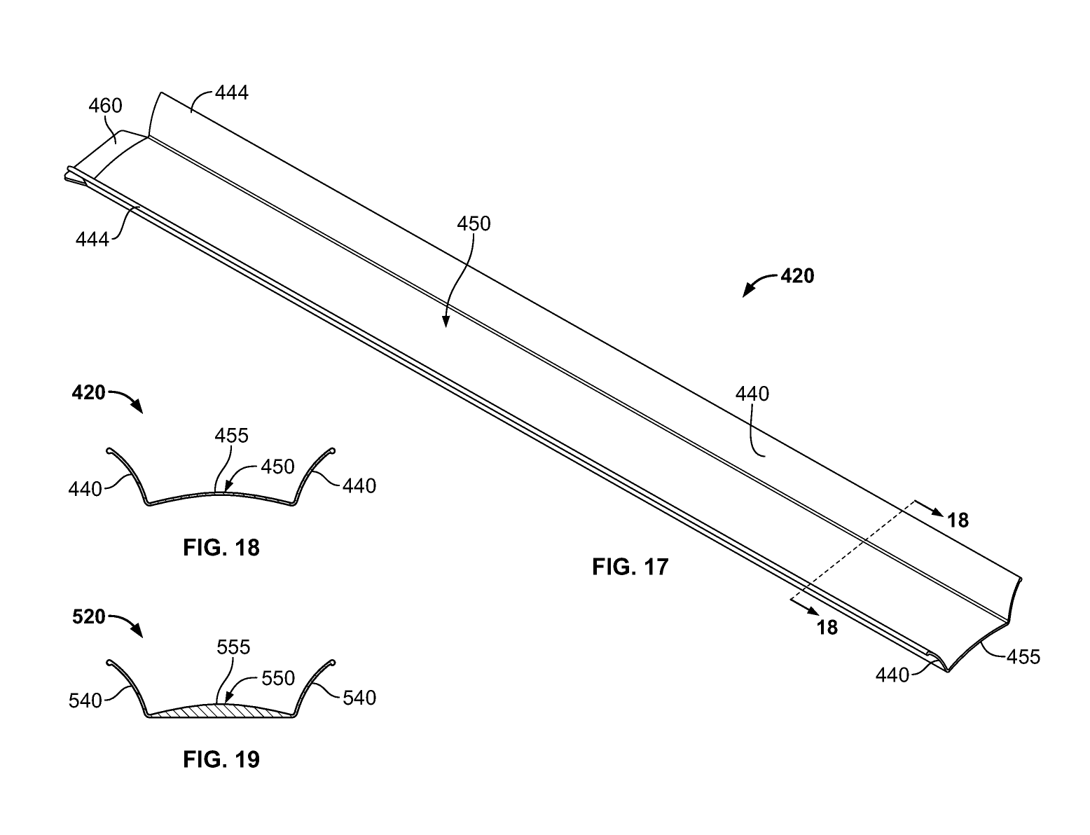

A ramp 420 is shown in FIGS. 17-18. The ramp 420 may include at least one frame member 440, a raised lip 444, a ramp surface 450 and at least one transition plate 460. The ramp 420 may be generally similar ramp 420 described above. The ramp 420 may be formed as a monolithic unit. In such embodiments, the ramp 420 may be formed such as through extruding. By way of a non-limiting example, the ramp 420 may be extruded as a single piece, which may result in the ramp 420 being a one-piece ramp. In such embodiments, the frame members 440 may be monolithically formed with the ramp surface 450 and transition plate 460. Any appropriate amount of material, such as by way of a non-limiting example, aluminum, steel, plastic or the like may be extruded to form the ramp 420.

The ramp surface 450 may include a crowned or transverse arched shape 455; such as shown in more detail in FIG. 18. The transverse arched shape 455 may extend an entire length of the ramp surface 450 or a portion thereof. By way of a non-limiting example, the transverse arched shape 455 may extend a majority portion of the length of the ramp surface 450. The transverse arch shape may enhance the strength of the ramp 420. Enhancing the strength of the ramp 420 may allow the ramp 420 to handle more weight during operation. In addition, it may permit the ramp 420 to include less material, which may reduce the cost and weight of the ramp 420. While a transverse arch shape 455 is shown, the present teachings are not limited to this shape. Any appropriate shape may be utilized that strengthens the ramp surface 450.

The present teachings generally eliminate the need to weld the ramp 420—as is done in the prior art. When the ramp 420 is made without welding, the ramp 420 may be referred to as being weld free. The process for forming the ramp 420 may minimize the labor required to complete the process. This may allow the ramp 420 to be manufactured quicker and may reduce the overall cost of the ramp 420.

In yet other embodiments, a ramp 520 may be similar to ramp 420—the ramp 520 may include at least one frame member 540 and a ramp surface 550. The ramp 520 may be monolithically formed. The ramp surface 550, however, may include a transverse arched shape 455 that extends from the ramp surface 450. In this embodiment, the transverse arched shape 455 may be formed by adding material to the ramp surface 450. This may increase the strength of the ramp 520 even further.

The present teachings generally eliminate the need to weld the ramp 520—as is done in the prior art. When the ramp 520 is made without welding, the ramp 520 may be referred to as being weld free. The process for forming the ramp 520 may minimize the labor required to complete the process. This may allow the ramp 520 to be manufactured quicker and may reduce the overall cost of the ramp 520.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, the following is claimed:

1. A ramp comprising:
a frame having first and second end portions;
a ramp surface extending substantially between the frame and positioned between the first and second end portions; and
a plate extending at least partially between the frame and positioned adjacent to at least one of the first and second end portions, wherein the frame, ramp surface and plate are monolithic.

2. The ramp of claim 1, wherein the frame includes a lip disposed above the ramp surface.

3. The ramp of claim 2, wherein the lip is monolithic with the frame.

4. The ramp of claim 1, wherein the frame includes first and second frame members transversely opposed to one another, the first and second frame members monolithic with the ramp surface and plate.

5. The ramp of claim 1, further comprising:
a bottom surface opposite the ramp surface; and
a safety strap engaging member positioned on the bottom surface.

6. The ramp of claim 5, wherein the safety strap engaging member comprises a ring attached with the bottom surface.

7. The ramp of claim 5, wherein the safety strap engaging member comprises an aperture formed in the bottom surface.

8. The ramp of claim 7, wherein the aperture extends through the ramp surface.

9. The ramp of claim 1, wherein the plate provides a transition surface between the ramp surface and a loading surface.

10. The ramp of claim 1, wherein the frame, ramp surface and plate are weld free.

11. A ramp comprising:
a frame having first and second end portions;
a ramp surface extending substantially between the frame and positioned between the first and second end portions; and
a plate extending at least partially between the frame and positioned adjacent to at least one of the first and second end portions, wherein the frame, ramp surface and plate are weld free.

12. The ramp of claim 11, wherein the frame, ramp surface and plate are monolithic.

13. The ramp of claim 11, wherein the ramp surface includes a plurality of apertures.

14. The ramp of claim 13, wherein the apertures extend entirely through the ramp surface.

15. The ramp of claim 11, wherein at least a portion of the ramp surface includes a textured surface.

16. The ramp of claim 11, further comprising a second plate positioned adjacent to another of the first and second end portions.

17. The ramp of claim 16, wherein the second plate, frame, ramp surface and plate are monolithic.

18. A ramp comprising:
first and second frame member transversely opposed one another, the first and second frame members having first and second end portions;
a ramp surface extending substantially between the first and second frame members and positioned between the first and second end portions; and
a plate extending at least partially between the first and second frame members and positioned adjacent to at least one of the first and second end portions of the first and second frame members, wherein the first and second frame members, ramp surface and plate are monolithic.

19. The ramp of claim 18, wherein the first and second frame members, ramp surface and plate are formed through extrusion.

20. The ramp of claim 18, further comprising:
a bottom surface opposite the ramp surface; and
a safety strap engaging member positioned on the bottom surface.

21. The ramp of claim 20, wherein the safety strap engaging member includes at least one of an aperture formed in the bottom surface and a ring attached with the bottom surface.

22. The ramp of claim 18, wherein the ramp surface includes a transverse arched shape that extends a majority portion of the ramp surface.
